(19) United States
(12) Patent Application Publication
(10) Pub. No.: US 2009/0299930 A1
(43) Pub. Date: Dec. 3, 2009

(54) Method of Measuring the Thickness Profile of a Film Tube

(75) Inventors: Stefan Konermann, Remscheid (DE); Michael Gunther, Koln-Widdersdorf (DE); Roland Pulch, Wuppertal (DE); Andreas Bartel, Wuppertal (DE); Markus Stein, Gevelsberg (DE)

Correspondence Address: RICHARD M. GOLDBERG, 25 EAST SALEM STREET, SUITE 419, HACKENSACK, NJ, 07601, US

(73) Assignee: PLAST-CONTROL GMBH, Remscheid (DE)

(21) Appl. No.: 12/471,646

(22) Filed: May 26, 2009

(30) Foreign Application Priority Data
May 30, 2008 (EP) 08 009 910.4

(51) Int. Cl. G06N 3/08; G06F 15/00

(52) U.S. Cl. 706/25; 702/172

(57) ABSTRACT

A method of measuring the thickness profile of a film produced in a blow film line having a rotatable pull-off rig in which a flattened film tube is scanned by performing individual measurements at measurement positions distributed over the width over the film tube and, in each individual measurement, the total thickness of two segments of the film tube is measured that are superposed at the measurement position, the thickness profile is calculated from the measured values obtained for a number individual measurements that is larger than the number of measurement positions, the improvement including the steps of training a neural network with measured values for the total thicknesses, which measured values have been obtained in simulated or real measurement processes with known thickness profiles and supplying the measured results obtained by scanning the film tube to the neural network for calculating the thickness profile.

The invention relates to a method of measuring the thickness profile of a film that has been produced in a blow film line having a rotatable pull-off rig (14), wherein
a flattened film tube (16) is scanned by performing individual measurements at measurement positions (i) that are distributed over the width of the film tube (16), wherein, in each individual measurement, the total thickness of two segments (28) of the film tube are measured that are superposed one upon the other at the measurement position, and
the thickness profile is calculated from the measurement results for a number of individual measurements that is larger than the number of measurement positions.

A method of this type is known form EP 1 207 368 A2.

In the production of blown films, the film bubble that has been extruded from an annular extrusion die and has been inflated with internal air does not show a completely uniform thickness profile on its circumference, because irregularities of the extrusion die and/or the cooling system lead to a certain distribution of thickened and thinned areas. When then, after having solidified, the film bubble is flattened to form a tube and is wound on a coil, if no countermeasures are taken, thickened areas would superpose thickened areas and thinned areas would superpose thinned areas, so that the thickness deviations would accumulate undesirably. For this reason, the film tube is flattened by means of a pull-off rig that can rotate relative to the film bubble. By varying the angular position of the pull-off rig, for example, by oscillation or rotation of the latter, it can be achieved that the thickened areas and the thinned areas are always displaced relative to one another in the flattened tube, so that a more uniform film belt is obtained on the coil.

In addition, one will of course always attempt to control the thickness profile by adjusting the extrusion die or the cooling system, so that the thickness deviations are reduced to minimum. To that end, it is necessary to continuously monitor the actual profile of the film.

In order to measure the thickness profile, a measuring head can be used which revolves around the film bubble before the latter is flattened, so that the measuring head will always measure a only single layer of the film. This, however, has the drawback that the measuring head can only be arranged on the external side of the film bubble and must therefore be capable of performing a thickness measurement from only a single side of the film. More exact thickness measurements can be obtained with measuring heads that comprise two parts that are arranged on opposite sides of the film.

In the method that has been described in the document cited above, a measuring head of the last-mentioned type is used. Then, the measurement is performed by scanning the film tube after it has been flattened. This, however, incurs the problem that the thickness measurement does not directly provide the thickness profile of the film, because it is only the sum of two film segments that are superposed one upon the other at the measurement position, that is measured in each measurement. When n individual measurements are performed in one scan of the film tube, this defines 2n segments of the film tube, for which the respectively associated thickness P(j) have to be determined. When 2n individual measurements are made, one obtains a system of equations with 2n equations and 2n unknowns. This system of equations can however not be solved exactly, because the individual equations are not linearly independent from one another.

This is why, in the known method, a significantly larger number of measurements is made, so that one obtains a correspondingly larger number of equations and hence an overconstrained system of equations which can then be solved approximately by the method of least square deviations.

It is important for an exact and stable control of the film profile that as little time as possible passes between the extrusion of a section of the film tube and the measurement of the thickness profile of this section, so that thickness deviations can be corrected with least possible delay.

It is an object of the invention to provide an alternative method of measuring the film thickness and an apparatus for carrying this method.

According to the invention, this object is achieved with the features indicated in the independent claims. According to the basic idea of the invention, the thickness profile is calculated by means of a neural network.

It turned out that even a neural network which has a relatively simple structure and is therefore fast and cheap and can be trained such that a robust and exact detection of the thickness profile on the basis of a relatively small number of measured values becomes possible. As an additional advantage, the neural network can also be used for correcting systematic errors of the measuring equipment when the network has been trained for a specific measuring equipment.

Useful details and further developments of the invention are indicated in the dependent claims.

An embodiment example will now be explained in detail in conjunction with the drawings, wherein:

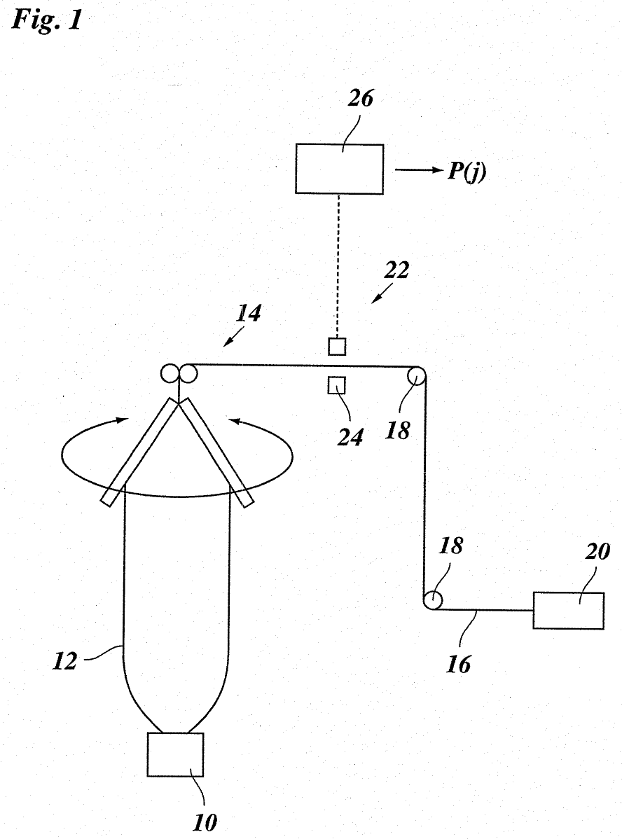

FIG. 1 is a conceptual sketch of a blow film line including a device for measuring the thickness profile that is suitable for carrying out the method according to the invention;

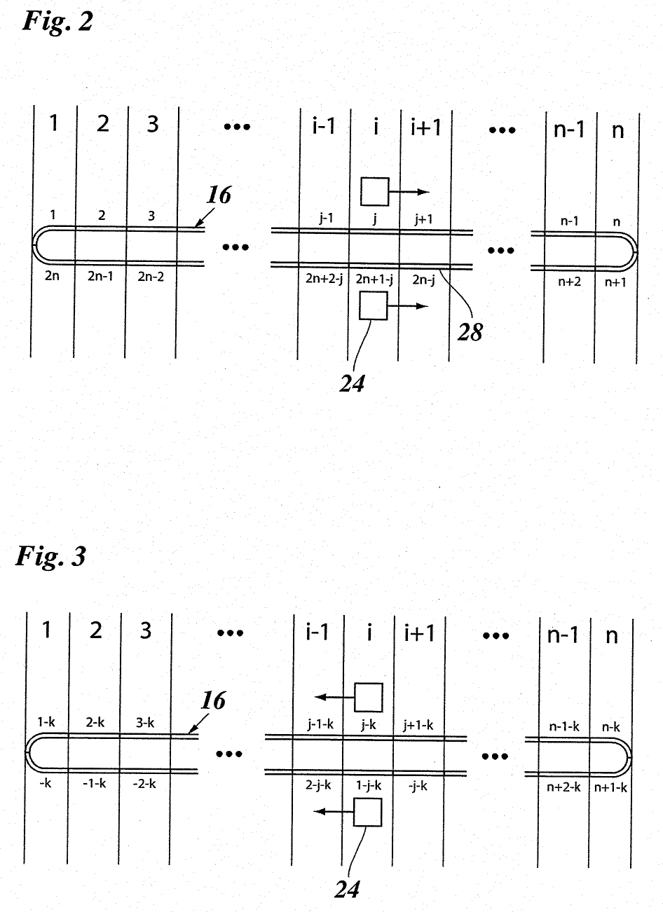

FIG. 2 a schematic cross-section of a flattened film tube in a first configuration;

FIG. 3 the film tube of FIG. 2 in a configuration rotated by k segments;

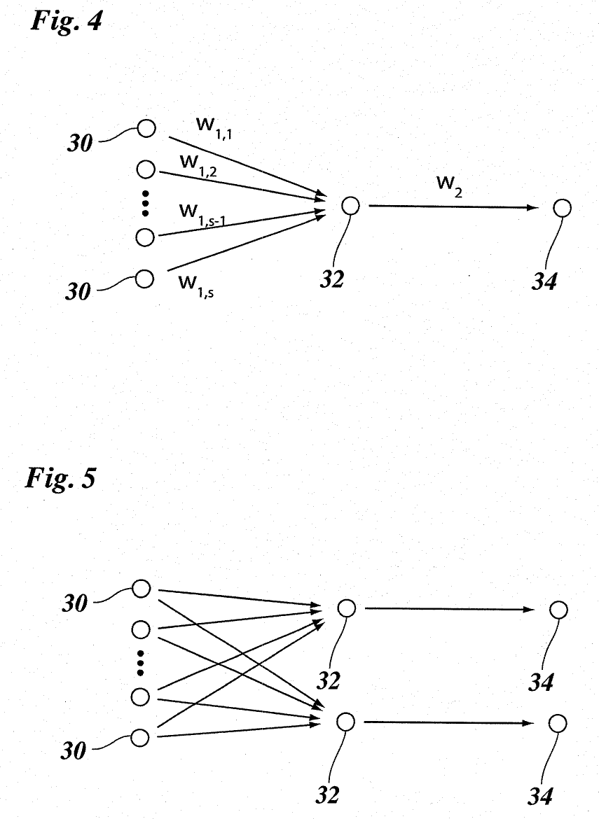

FIGS. 4 and 5 conceptual sketches of neural networks;

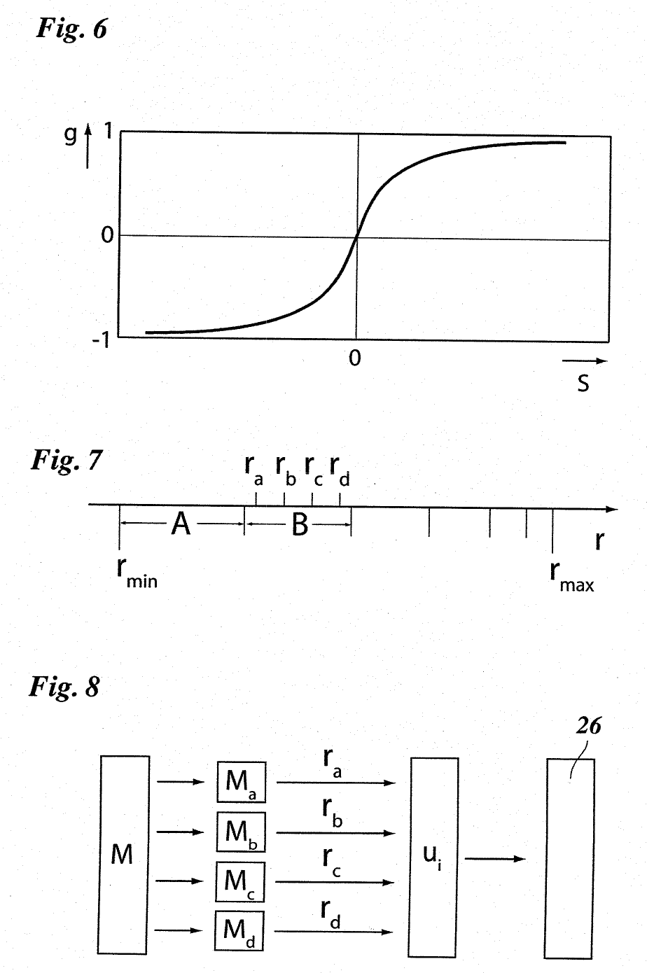

FIG. 6 a graph of an activation function;

FIG. 7 a diagram for different speeds of rotation of the film bubble; and

FIG. 8 a block diagram of a method for training the neural network.

FIG. 1 schematically shows a blow film line which includes, as usual, an extrusion die 10 from which a tubular film bubble 12 is extruded vertically upwardly and is inflated with internal air so that the film will be stretched and thinned until it is finally solidified in the upper portion of the film a bubble. At the upper end, the film bubble 12 is then flattened by means of a rotating or reversing pull-off rig 14. In this way, one obtains a flattened, i. e. double-layer film tube 16 which is fed via deflection rollers 18 towards a cutting and winding station 20 which has only been shown schematically and where the tube is cut into a single film web or two single-layer film webs and is wound on a coil. Immediately behind the exit of the pull-off rig 14, the film tube 16 passes through a measuring station 22 where the total thickness of the film tube is scanned by means of a measuring head 24 that is movable in transverse direction of the film tube. The measuring head 24 has two parts, (e. g. a transmitter and a receiver), which are disposed above and below the film tube 16. Because of this construction of the measuring head 24, the measurement can only be performed at the flattened film tube 16 and not yet at the film bubble 12. On the other hand, the measurement shall take place already upstream the cutting and winding station 20 in order for the measurement results to be available as early as possible for the feedback control of the thickness profile of the film.

The measurement results obtained in the measuring station 22 are supplied to a neural network 26 which is used for calculating the thickness profile P(j) of the film bubble. The neural network 26 can be formed by dedicated hardware or by a suitably programmed multi-purpose data processing system, preferably with parallel architecture.

FIG. 2 shows a schematic cross-section of the film tube 16 at the position of the measuring station 22. The parts of the measuring head 24 that are disposed above and below the film tube 16 are moved synchronously in width direction of the film tube, towards the right, in the example shown, and measure the total thickness of the double-layer film tube at n measurement positions that are equally distributed over the width of the film tube and are designated here by the index i. Since the film tube has two layers, the n measurement positions define 2n segments 28 of the tube, which are designated here by the index j. Since these segments are arranged cyclically in the tube, it is advantageous to define the indices i and j as integers modulo 2n, i. e. 2n=0, 2n+1=1, 2n−1=−1, etc.

The requested thickness profile P(j) is then represented by the thickness values for each of the 2n segments 28 of the tube.

In the configuration shown in FIG. 2, the segment 1 of the tube overlays the segment 2n (or 0), the segment 2 overlays the segment 2n−1, etc., so that, in general, the segment j overlays the segment 2n+1−j, and the indices i and j are equal for the upper segments of the film tube, i. e. the segments 1 to n.

FIG. 3 shows the same film tube 16 in a second configuration in which it has been rotated by k segments as a result of the rotation of the pull-off rig 14. Thus, it is no longer the segment j=1 but rather the segment j=1−k that is located at the measurement position i=1. Correspondingly, all the other segments are also shifted by k, towards the right on the top side of the film tube and towards the left of the lower side when k is positive.

In repeated scans, wherein the measuring head 24 is for example moved alternatingly towards the right and towards the left over the width of the film tube, one obtains a sequence of measured values that respectively indicate the sum of the thicknesses of two segments. In practice, the time T_{M} that is needed for one scan, i. e. a complete movement of the scanning head 24 over the width of the film tube (i. e. for n measurements), will be significantly smaller than the time T_{F} which the pull-off rig 14 needs for one turn or, as the case may be, one half oscillation cycle. Thus, the configuration of the film tube may be considered as constant during a sequence of individual measurements directly succeeding one upon the other, e. g. during a scan or a part thereof. In successive scans, however, the segments of the film tube will gradually be displaced relative to one another, so that one obtains measurement results for different pairs of film segments. In practice, T_{M} will for example amount to 20 to 30 s, and T_{F} will be 300 to 3000 s, for example. These figures and the number 2n of the segments of the film tube should preferably be coordinated such that the superposed segments of the film tube are shifted relative to one another by at least one segment during one scan, i. e. in the time T_{M}.

It is now the purpose of the neural network 26 to derive, from these measured values which will include measured values for different configurations of the film tube and hence for different pairings of segments, the values for the thicknesses P(j) of the individual segments and hence the thickness profile of a the film with highest possible accuracy.

FIG. 4 illustrates a simple example of a neural network. As usual, the network has a number of neurons 30, 32, 34 that are arranged in several layers, three layers in the example shown. A first layer is formed by input neurons 30 which receive the measured values. The number of input neurons 30 must be larger than n and should preferably be at least 2n, so that the neural network is capable of processing 2n individual measurements, i. e, the measurements from two successive scans, in parallel.

A second layer of the neural network is a so-called hidden layer and is formed by neurons 32, and the third layer is formed by output neurons 34. In the example shown, the hidden layer has only a single neuron 32, and the third layer has only a single output neuron 34. Consequently, this network can deliver as a result only a single value (the value of the output neuron 34) which represents the thickness of a single segment of the film tube. Consequently, 2n neural networks of the type shown in FIG. 4 are needed for obtaining a complete thickness profile of the film tube with 2n segments. These 2n networks may however also be considered as a single larger network. This has been shown schematically in FIG. 5 for the simple case of a network with two output neurons 34.

In FIG. 4, each input neuron 30 is linked to the hidden neuron 32 by a weight w_{1,1} . . . w_{1,s} (s=1 . . . . 2n). The neuron 32 is linked to the output neuron 34 by a weight w₂.

If uᵢ (i=1 . . . 2n) is a set of measured values that are supplied to the input neurons 30, then the value v of the neuron 32 is calculated in accordance with the following formula:

v=g₁(Σw_{1,i} uᵢ+bᵢ) (1)

In this formula, g₁ is a so-called activation function, and b₁ are so-called threshold values, and i is the summation index.

An example of a suitable activation function is a hyperbolic tangent function, the graph of which has been shown in FIG. 6. There, the value g of the activation function is given as a function of the sum S which corresponds to the sum in equation (1). It can be seen that the sum S may assume both, positive and negative values. It is assumed here that the measured values uᵢ indicate the deviations from the mean film thickness or target film thickness and may therefore also be either positive or negative. The codomain of the activation function is the interval [−1, 1]. Since this function is continuous (and differentiable) g may assume any value within this interval.

In the general case of a neural network, i. e. a network having a plurality of neurons in the hidden layer, the value of each of the hidden neurons 32 is determined by a formula of the same type as the formula (1), but with different weights (the totality of the weights w, will then form a matrix). The value P(j) of each output neuron is calculated according to a formula that is analogous to the formula (1). Since, however, in the example that has been considered here, there is only a single hidden neuron 32 and a single output neuron 34, the formula for the value of the output neuron 34 reduces to:

P(j)=g₂(w₂ v+b₂) (2)

Here, g₂ is again an activation function, and b₂ is a threshold value. In this case, the activation function g₂ may also be a linear function (a first order polynomial).

As is commonly known in the theory of neural networks, the weights w_{1,i}, w₂ and the threshold values b_{1,i} and b₂ must be determined by training the neural network on the basis of known results. In the present case, a number of known (real or fictitious) thickness profiles are needed for training the network. Then, for each of these profiles, the measuring process illustrated in FIG. 1 to 3 is performed or simulated with predetermined values for T_{M} and T_{F}.

In the simulation, the value P(j) that is indicated by the thickness profile, is assigned to each of the 2n segments of the film tube, and the sum of the thicknesses of the two superposed segments is calculated and supplied to the neural network as a fictitious measured value uᵢ for each position i of the a measuring head 24. In this process, it is also taken into account that the segments are shifted relative to one another in the course of the successive measurements, as illustrated in FIG. 3.

Then, the weights and the threshold values have to be calculated such that for each of the thickness profiles that have been used for the training, the network delivers at each output neuron 34 as exactly as possible the thickness P(j) of the segment j associated with this neuron, when the corresponding fictitious measured values uᵢ are supplied to the input neurons 30. Several algorithms for calculating the weights and the threshold values are known in the theory of neural networks. These algorithms shall not be discussed here in detail.

It will be understood that, in place of the relatively simple neural network that has been described here, more complex networks may also be used, e. g. networks having several neurons in the hidden layer or networks having two or more hidden layers.

In principle, the method of training the neural network that has been described above is independent from the specific measuring equipment. It is therefore sufficient to provide one trained network which then can be used for all measurement equipments that are operated with the same values for T_{M}, T_{F} and n.

However, it is also possible that, for training the neural network, real measured values are used which are measured with the measuring head 24 at a real film tube, in conjunction with profiles which have been measured at the single-layer film after the film tube has been cut. Then, when the neural network is employed for a measurement equipment that has also been used for obtaining the training data, the neural network will also eliminate systematic errors of the measuring equipment.

In practice, it will frequently be necessary, depending upon the type of film blowing process, dimensions and composition of the film tube, and desired accuracy, to perform the measurement of the thickness profile with different scanning speeds of the measuring head 24 and with different reversal or rotation frequencies of the pull-off rig 14, so that the duration T_{F} of the reversal and the duration T_{M} of a scan must be treated as variable parameters. In principle, it is possible to train a specific neural network, i. e. to determine a specific set of weights and threshold values, for each combination of these parameters. Then, depending on the desired accuracy, the number of possible combinations of parameters may however become relatively large.

It is also possible to train, for all possible parameters and combinations of parameters, a unique network wherein a corresponding input neuron is provided for each parameter.

A possibility to train a robust network with relatively low complexity will now be described.

At first, it should be noted that it is neither the duration T_{F} of the reversal process as such nor the duration T_{M} of the scan as such that is relevant for a suitable training of the neural network, but rather the ratio r=T_{M}/T_{F}. This ratio is equal to the ratio of scanning speed/reversal speed and shall therefore be termed speed ratio r in what follows. This speed ratio may in practice assume different values within an interval [rₘᵢₙ, rₘₐₓ], as shown in FIG. 7. This interval is now divided into several sub-intervals A, B, . . . , and a specific neural network is trained for each of these sub-intervals. As is shown in FIG. 7, the sub-intervals A, B . . . , have different sizes. This makes it possible to take into account that the sensitivity with which the neural network reacts on fluctuations of the speed ratio r is itself dependent on the speed ratio r. In general, the sensitivity increases with increasing r, e. g. exponentially. Correspondingly, the size of the sub-intervals decreases with increasing r in FIG. 7.

Now, for training the neural networks for the individual sub-intervals A, B, . . . , it is possible for example to use measured values uᵢ which are respectively measured or simulated for the value r in the center of the respective interval.

FIG. 8 illustrates an alternative training process which can achieve a higher robustness vis-a-vis fluctuations of the speed ratio r for a neural network with reality low complexity. As usual, a certain set M of thickness profiles is used. This set is divided into a certain number, four in this example, of subsets Mₐ-M_{d} of equal size. Now, for determining the corresponding measured values uᵢ (by simulation or real measurements), a different speed ratio rₐ, r_{b}, r_{c}, r_{d} is assumed for each subset. As shown in FIG. 7, these speed ratios rₐ, r_{b}, r_{c}, r_{d} are equally distributed over the sub-interval B.

In this way, one obtains a training database, consisting of thickness profiles and associated measured values us, in which a certain fluctuation of the speed ratio r within the sub-interval B is already “built in”. Then, the neural network 26 that has been trained with this training database is relatively insensitive to fluctuations of the speed ratio r within the sub-interval B. Thus, when the speed ratio r is within the sub-interval B during the blow film production process and the feedback control of the thickness profile, one obtains relatively good results with the neural network 26 trained in this way.

The same is done for the other sub-intervals A, etc., so that, finally, a suitable neural network is available for each speed ratio r of practical relevance.

In a blow film line wherein the pull-off rig 14 is a reversing rig, i. e. the rig is alternatingly rotated in opposite directions through an angle of 360° or less, the result obtained by means of the neural network may also depend upon the direction in which the pull-off rig 14 moves. This can be taken into account by providing separate neural networks for the two opposite directions of rotation of the pull-off rig.

What is claimed is:

1. A method of measuring the thickness profile of a film produced in a blow film line having a rotatable pull-off rig, comprising the steps of:
scanning a flattened film tube by:
performing individual measurements at measurement positions distributed over the width over the film tube, and
measuring, in each individual measurement, the total thickness of two segments of the film tube that are superposed at the measurement position,
calculating the thickness profile from measured values obtained for a number of individual measurements that is larger than the number of measurement positions,
training a neural network with measured values for the total thicknesses, which measured values have been obtained in one of simulated and real measurement processes with known thickness profiles, and
supplying measured results obtained by scanning the film tube to the neural network for calculating the thickness profile.

2. The method according to claim 1, wherein the number of measured values that are supplied to the neural network for calculating an individual thickness profile is at least twice the number of measurement positions.

3. The method according to claim 1, wherein the neural network has three layers of neurons.

4. The method according to claim 3, wherein a number of neurons in an intermediate layer of the neural network is equal to the number of segments of the film tube, and each segment is assigned to exactly one neuron of the intermediate layer.

5. The method according to claim 1, wherein the step of training the neural network includes using measured values that have been measured in advance at at least one real film tube, using measuring equipment with which the method is carried out, and the thickness profiles used for training are profiles that have been measured at single-layer films after the film tubes have been cut lengthwise.

6. The method according to claim 1, wherein the step of training the neural network includes the steps of:
dividing a set of thickness profiles into several subsets for which the measured values associated with the individual thickness profiles are determined under the condition that a ratio between the duration of an individual turn of the pull-off rig and the duration of a single scan of the film tube has values which are equal within each subset but are different from subset to subset, and
using the totality of thickness profiles and measured values of all subsets for training the neural network.

7. The method according to claim 1, wherein operating parameters of the blow film line, including at least one of:
the duration of a single turn of the pull-off rig,
the duration of an individual scan of the film tube, and
the ratio of these durations, are supplied as input values to corresponding input neurons of a unique network that has been trained for one of:
different parameters, and
different combinations of parameters.

8. The method according to claim 7, comprising the step of training the unique network with different parameters, respectively, for different sub-intervals of the domain in which the ratio varies, and the size of the individual sub-intervals depends on the value of the ratio.

9. Equipment for measuring the thickness profile of a film tube produced in a blow film line having a rotatable pull-off rig and a system for flattening the film tube, comprising:
a measuring station for scanning the flattened film tube with a measuring head that is movable across the width of the film tube, said measuring head being adapted to measure, at each of several positions distributed over the width of the film tube, the total thickness of two segments of the film tube that are superposed one upon the other at a measurement position, and
a system for calculating a thickness profile from the measurement results, the system for calculating the thickness profile including a neural network.

10. The method according to claim 1, further comprising the step of training several neural networks, for measurement conditions that are different from one another in terms of the ratio between the duration of a single turn of the pull-off rig and the duration of a single scan of the film tube.
